(19) United States
(12) Patent Application Publication
(10) Pub. No.: US 2012/0216765 A1
(43) Pub. Date: Aug. 30, 2012

(54) ENGINE COOLING SYSTEM AND MOTOR THEREFOR

(76) Inventors: Rui Feng QIN, Hong Kong (CN); Ling YANG, Shenzhen (CN); Chang Jin ZHOU, Shenzhen (CN); Xin Hui GUAN, Shenzhen (CN)

(21) Appl. No.: 13/404,999

(22) Filed: Feb. 24, 2012

(30) Foreign Application Priority Data
Feb. 25, 2011 (CN) 201110046431.8

(51) Int. Cl. F01P 5/04; F04B 35/04; H02K 3/28

(52) U.S. Cl. 123/41.49; 310/195; 417/423.7

(57) ABSTRACT

An engine cooling system includes an engine, a coolant tank, a radiator, a cooling module for cooling the radiator, and connecting pipes connecting the engine, the coolant tank and the radiator to form a loop. The cooling module includes a motor and an impeller. The motor includes a stator and a rotor. The stator forms 2P stator poles, wherein P is a positive integer. The rotor includes a shaft, a rotor core, and windings wound around the rotor core. The rotor core includes n teeth and forms n winding slots between the teeth. A slot has a radial depth less than one of the other slots. The number of winding slots n is a multiple of the number of stator poles. The windings includes coils each of which is wound about n/2P teeth.

### CROSS REFERENCE TO RELATED APPLICATIONS

This non-provisional patent application claims priority under 35 U.S.C.§119(a) from Patent Application No. 201110046431.8 filed in The People's Republic of China on Feb. 25, 2011.

### FIELD OF THE INVENTION

This invention relates to an engine cooling system, and in particular, to an electric motor for the engine cooling system.

### BACKGROUND OF THE INVENTION

A typical motor for an engine cooling system, as disclosed by US Patent Application publication number US20080201928, includes 4 permanent magnets forming 4 stator poles, and a rotor having 20 teeth forming 20 winding slots. Rotor windings are wound about the teeth. An axial length of such type of motor is large due to cross over of the winding heads.

Therefore, there is a desire for an improved motor which can overcome the above described shortcoming.

### SUMMARY OF THE INVENTION

Accordingly, in one aspect thereof, the present invention provides an engine cooling system comprising: an engine; a coolant tank; a radiator; a plurality of connecting pipes connecting the engine, the coolant tank and the radiator to form a loop; and a cooling module for cooling the radiator, the cooling module comprising a motor and an impeller driven by the motor, the motor comprising a stator and a rotor rotatably mounted confronting the stator, the stator forming 2P stator poles and wherein P is a positive integer, the rotor comprising a shaft, a rotor core fitted to the shaft, and a plurality of windings wound around the rotor core, the rotor core comprising n teeth and forming n winding slots between the teeth, wherein the number of the winding slots n is a multiple of the number of the stator poles 2P, at least one slot having a radial depth less than that of at least one of the other slots, the windings comprising a plurality of coils, and each of the coils is wound about n/2P teeth.

Preferably, P is 2, and n is 20.

Preferably, the winding slots are arranged in two or more groups of slots, along a first circumferential direction, each group comprising: a first slot; n/2P−1 continuous second slots continuously arranged downstream of the first slot; and a plurality of continuous third slots continuously arranged downstream of the second slots, wherein radial depths of the first winding slot and the second winding slots are gradually reduced along the first circumferential direction.

Preferably, coils wound first start from the first slot, and coils wound latter start from a corresponding winding slot that is next to the winding slot where the former wound coil started.

Preferably, the winding slots are arranged into a plurality of groups of slots, and the first slots of the plurality of groups are equidistantly arranged along a circumference of the rotor core.

Preferably, the third slots are inclined towards the first circumferential direction, while the other slots are inclined towards a direction opposite to the first circumferential direction.

Preferably, the tooth between the first slot and the adjacent second slot defines a cutout at a radially outermost face thereof for identifying the first slot during winding.

Preferably, radially innermost edges of the third slots are substantially located on an imaginary circle.

Preferably, openings of all the winding slots are equidistantly arranged along the circumference of the rotor core.

According to a second aspect, the present invention provides a cooling module for an engine cooling system, comprising: an impeller; and a motor driving the impeller, the motor comprising a stator and a rotor rotatably mounted confronting the stator, the stator forming 2P stator poles and wherein P is a positive integer, the rotor comprising a shaft, a rotor core fitted to the shaft, and a plurality of windings wound around the rotor core, the rotor core comprising n teeth and forming n winding slots between the teeth, wherein the number of winding slots n is a multiple of the number of stator poles 2P, at least one slot having a radial depth less than that of at least one of the other slots, the windings comprising a plurality of coils, and each of the coils being wound about n/2P teeth.

Preferably, P is 2, and n is 20.

Preferably, the winding slots are arranged in two or more groups of slots, along a first circumferential direction, each group comprising: a first slot; n/2P−1 continuous second slots continuously arranged downstream of the first slot; and a plurality of continuous third slots continuously arranged downstream of the second slots, wherein radial depths of the first winding slot and the second winding slots are gradually reduced along the first circumferential direction.

Preferably, the winding slots are arranged into a plurality of groups of slots, and the first slots of the plurality of groups are equidistantly arranged along a circumference of the rotor core.

Preferably, the third slots are inclined towards the first circumferential direction, while the other slots are inclined towards a direction opposite to the first circumferential direction.

Preferably, radially innermost edges of the third slots are substantially located on an imaginary circle.

According to a further aspect, the present invention provides an electric motor for an engine cooling system, comprising: a stator forming 2P stator poles, wherein P is a positive integer; and a rotor rotatably mounted confronting the stator, the rotor comprising a shaft, a rotor core fitted to the shaft, and a plurality of windings wound around the rotor core, the rotor core comprising n teeth and forming n winding slots between the teeth, wherein the number of winding slots n is a multiple of the number of stator poles 2P, at least one slot having a radial depth less than that of at least one of the other slots, the windings comprising a plurality of coils, and each of the coils being wound about n/2P teeth.

Preferably, P is 2, and n is 20.

Preferably, the winding slots are arranged in two or more groups of slots, along a first circumferential direction, each group comprising: a first slot; n/2P−1 continuous second slots continuously arranged downstream of the first slot; and a plurality of continuous third slots continuously arranged downstream of the second slots, wherein radial depths of the first winding slot and the second winding slots are gradually reduced along the first circumferential direction.

Preferably, the winding slots are arranged into a plurality of groups of slots, and the first slots of the plurality of groups are equidistantly arranged along a circumference of the rotor core.

Preferably, radially innermost edges of the third slots are substantially located on an imaginary circle.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a schematic diagram of an engine cooling system according to an embodiment of the present invention;

FIG. 2 is an isometric view of a motor of the engine cooling system of FIG. 1;

FIG. 3 is a view similar to FIG. 2, but with an end cap of the motor removed to show an interior structure of the motor;

FIG. 4 is a plan view of a rotor core of the motor of FIG. 2; and

FIG. 5 shows the rotor core of FIG. 4 with windings wound thereon.

### DETAILED DESCRIPTION OF THE PREFERRED EMBODIMENTS

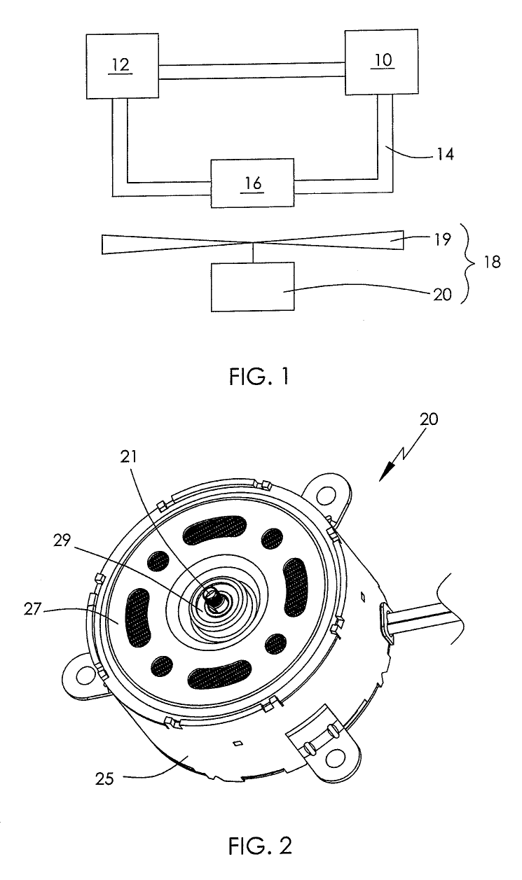

Referring to FIG. 1, an engine cooling system according to the present embodiment includes an engine 10, a coolant tank 12, a radiator 16, a cooling module 18 for cooling the radiator 16, and a number of connecting pipes 14 connecting the engine 10, the coolant tank 12, and the radiator 16 to form a heat dissipation loop. The coolant tank 12 is filled with coolant such as water. The coolant driven by a pump (not shown) flows from the coolant tank 12 and enters cooling channels of the engine 10 and absorbs heat from the engine 10, and then the coolant flows through the radiator 16 where the coolant releases its heat, then the coolant return back to the coolant tank 12 via the connecting pipes 14 for another cycle. The cooling module 18 removes heat from the radiator 16 such that the radiator 16 is able to continuously absorb heat from the coolant.

The cooling module 18 includes a motor 20 and an impeller 19 driven by the motor 20. When the impeller 19 is rotated, it produces a flow of air to the radiator 16.

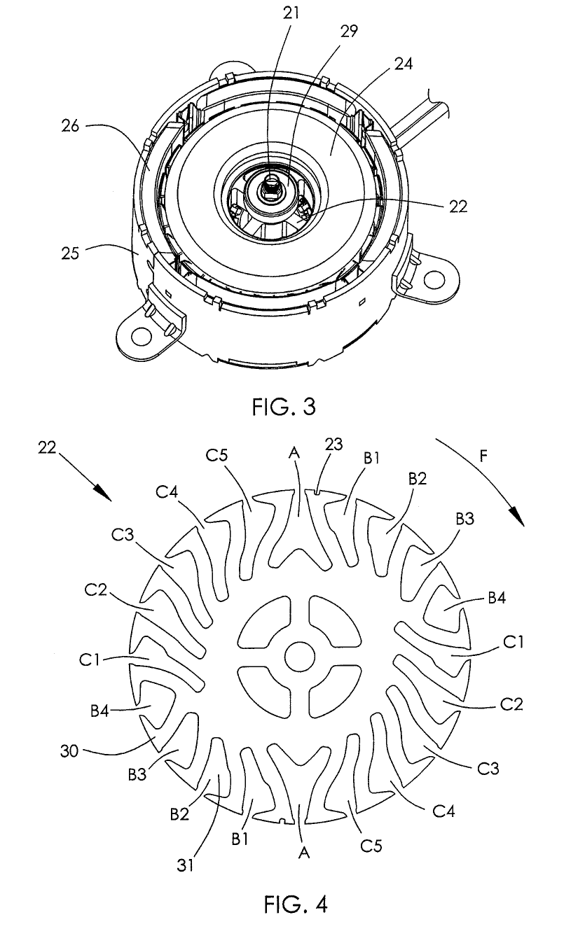

Referring to FIGS. 2 through 5, the motor 20 includes a stator and rotor rotatably mounted confronting the stator. The stator includes a housing 25, 4 permanent magnets 26 attached to an inner surface of the housing 25, an end cap 27 connected to an open end of the housing 25, and a bearing 29 mounted on the end cap 27. In this embodiment, the permanent magnets 26 form 4 stator poles. A second end cap is fitted to second open end of the housing and supports a second bearing for the shaft.

The rotor includes a shaft 21, a rotor core 22 and a commutator (not shown) fitted to the shaft 21, and windings 24 wound on the rotor core 22 and terminated on the commutator. The rotor is rotatably supported by the bearings. The impeller 19 is fitted to the shaft 21 so as to rotate with the shaft.

The rotor core 22 includes 20 teeth 30 and defines 20 winding slots 31 between the teeth 30. That is, the number of teeth 30 equals the number of winding slots 31. The number of teeth 30 is a multiple of the number of stator poles, which is shown as 4 in this embodiment. If the number of stator poles is expressed as 2P (P is a positive integer), and the number of winding slots 31 is expressed as n, then n is larger than the stator pole number 2P, and n is a multiple of the stator pole number 2P.

Every two adjacent teeth 30 define a winding slot 31 there between. The winding slots 31 are arranged and shaped such that the stator core 22 is asymmetric. The winding slots 31 can be divided into two groups of slots which are identical. Each group includes a first winding slot A, 4 continuous second slots B1-B4, and 5 continuous third slots C1-C5. In other words, each group of the winding slots 31 includes a first slot A, n/2P−1 continuous second slots B1-B4, and a number of third slots C1-C5. The first slot A, the second slots B1-B4 and the third slots C1-C5 are arranged in sequence along a first circumferential direction F, such as clockwise direction in this embodiment. More specifically, along the first circumferential direction, the second slots B1-B4 are located downstream of the first slot A, and the third slots C1-C5 are located downstream of the second slots B1-B4.

The first slot A has a maximum radial depth. The next second slots B1-B4, have gradually reducing radial depths. The third slots C1-C5 have maximum radial depths and similar shapes. Radially innermost edges of the third slots C1-C5 are substantially located on an imaginary circle.

In the present embodiment, the first slots A of the two groups are arranged symmetrically about the central axis of the rotor core 22 to improve balance of the rotor. It should be understood that the rotor core 22 may include more than two groups of slots, in that case, all of the first slots A should be arranged equidistantly spaced along the circumference of the rotor core 22, such that the balance of the rotor can be improved.

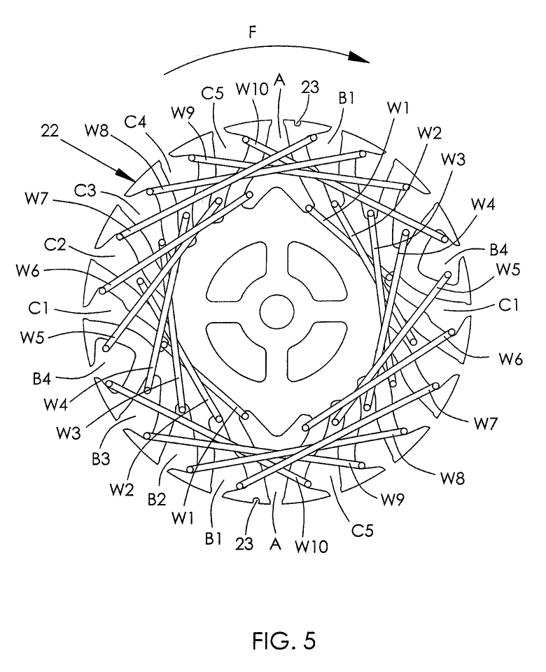

FIG. 5 illustrates the winding pattern or configuration by using lines W1 to W10 to express coils of the windings 24. Each coil spans 5 teeth 30, i.e., n/2P teeth. Coils W1 are wound first and start from the first slot A. Coils W2 are wound next and start from the adjacent second slot B1. Coils W3 are wound next and start from the next second slot B2. Thereafter, coils W4 to W10 are wound in turn in such a manner that coils wound latter start from a corresponding winding slot that is next to the winding slot where the former wound coils started. As the depths of the first slot A and the second slots B1-B4 are regularly reduced, the windings 24 only slightly overlap each other, such that an axial height of the winding heads can be kept small. Accordingly, the axial height of the motor 20 is small.

Two cutouts 23 are defined in two diametrically opposed radial outermost faces of the teeth 30, which are known as pole faces. This cutouts 23 are used as a guide for identifying the first slot during winding. The cutouts 23 are preferably formed on the tooth between the first winding slot A and the adjacent second winding slot B1, and located closer to the first winding slot A than to the second winding slot B1.

In the present embodiment, the openings of all the winding slots 31 are equidistantly arranged along the circumference of the rotor core 22 for easily automatic winding. The teeth 30 that forming the third winding slots C1-C5 are inclined towards the first circumferential direction F, while the teeth 30 forming the other slots A and B1-B4 are inclined towards a direction opposite to the first circumferential direction F, so as to facilitate automatic winding and to reduce the overlap between the windings.

As described above, in this embodiment, the motor is a 4-pole 20-slot motor, and each coil spans n/2P teeth, such that the torque of the motor 20 is increased. It should be understood that the number of the poles and the slots may be changed in case of need, as long as the number of the winding slots n is larger than the stator pole number 2P and is a multiple of the stator pole number 2P.

Although the invention is described with reference to one or more preferred embodiments, it should be appreciated by those skilled in the art that various modifications are possible. Therefore, the scope of the invention is to be determined by reference to the claims that follow. It should be noted that although the coolant tank of the engine cooling system has been described as though it is a separate independent item, in practice the coolant tank may be formed as a part of the radiator.

In the description and claims of the present application, each of the verbs “comprise”, “include”, “contain” and “have”, and variations thereof, are used in an inclusive sense, to specify the presence of the stated item but not to exclude the presence of additional items.

1. An engine cooling system comprising:
an engine;
a coolant tank;
a radiator;
a plurality of connecting pipes connecting the engine, the coolant tank and the radiator to form a loop; and
a cooling module for cooling the radiator, the cooling module comprises a motor and an impeller driven by the motor, the motor comprising a stator and a rotor rotatably mounted confronting the stator, the stator forming 2P stator poles and wherein P is a positive integer, the rotor comprising a shaft, a rotor core fitted to the shaft, and a plurality of windings wound around the rotor core, the rotor core comprising n teeth and forming n winding slots between the teeth, wherein the number of the winding slots n is a multiple of the number of the stator poles 2P, at least one slot having a radial depth less than that of at least one of the other slots, the windings comprising a plurality of coils, and each of the coils is wound about n/2P teeth.

2. The engine cooling system of claim 1, wherein P is 2, and n is 20.

3. The engine cooling system of claim 1, wherein the winding slots are arranged in two or more groups of slots, along a first circumferential direction, each group comprising:
a first slot;
n/2P−1 continuous second slots continuously arranged downstream of the first slot; and
a plurality of continuous third slots continuously arranged downstream of the second slots,
wherein radial depths of the first winding slot and the second winding slots are gradually reduced along the first circumferential direction.

4. The engine cooling system of claim 3, wherein coils wound first start from the first slot, and coils wound latter start from a corresponding winding slot that is next to the winding slot where the former wound coil started.

5. The engine cooling system of claim 3, wherein the winding slots are arranged into a plurality of groups of slots, and the first slots of the plurality of groups are equidistantly arranged along a circumference of the rotor core.

6. The engine cooling system of claim 3, wherein the third slots are inclined towards the first circumferential direction, while the other slots are inclined towards a direction opposite to the first circumferential direction.

7. The engine cooling system of claim 3, wherein the tooth between the first slot and the adjacent second slot defines a cutout at a radially outermost face thereof for identifying the first slot during winding.

8. The engine cooling system of claim 3, wherein radially innermost edges of the third slots are substantially located on an imaginary circle.

9. The engine cooling system of claim 1, wherein openings of all the winding slots are equidistantly arranged along the circumference of the rotor core.

10. A cooling module for an engine cooling system, comprising:
an impeller; and
a motor driving the impeller, the motor comprising a stator and a rotor rotatably mounted confronting the stator, the stator forming 2P stator poles and wherein P is a positive integer, the rotor comprising a shaft, a rotor core fitted to the shaft, and a plurality of windings wound around the rotor core, the rotor core comprising n teeth and forming n winding slots between the teeth, wherein the number of winding slots n is a multiple of the number of stator poles 2P, at least one slot having a radial depth less than that of at least one of the other slots, the windings comprising a plurality of coils, and each of the coils being wound about n/2P teeth.

11. The cooling module of claim 10, wherein P is 2, and n is 20.

12. The cooling module of claim 10, wherein the winding slots are arranged in two or more groups of slots, along a first circumferential direction, each group comprising:
a first slot;
n/2P−1 continuous second slots continuously arranged downstream of the first slot; and
a plurality of continuous third slots continuously arranged downstream of the second slots,
wherein radial depths of the first winding slot and the second winding slots are gradually reduced along the first circumferential direction.

13. The cooling module of claim 12, wherein the winding slots are arranged into a plurality of groups of slots, and the first slots of the plurality of groups are equidistantly arranged along a circumference of the rotor core.

14. The cooling module of claim 12, wherein the third slots are inclined towards the first circumferential direction, while the other slots are inclined towards a direction opposite to the first circumferential direction.

15. The cooling module of claim 12, wherein radially innermost edges of the third slots are substantially located on an imaginary circle.

16. A motor for an engine cooling system, comprising:
a stator forming 2P stator poles, wherein P is a positive integer; and
a rotor rotatably mounted confronting the stator, the rotor comprising a shaft, a rotor core fitted to the shaft, and a plurality of windings wound around the rotor core, the rotor core comprising n teeth and forming n winding slots between the teeth, wherein the number of winding slots n is a multiple of the number of stator poles 2P, at least one slot having a radial depth less than that of at least one of the other slots, the windings comprising a plurality of coils, and each of the coils being wound about n/2P teeth.

17. The motor of claim 16, wherein P is 2, and n is 20.

18. The motor of claim 16, wherein the winding slots are arranged in two or more groups of slots, along a first circumferential direction, each group comprising:
a first slot;
n/2P−1 continuous second slots continuously arranged downstream of the first slot; and
a plurality of continuous third slots continuously arranged downstream of the second slots,
wherein radial depths of the first winding slot and the second winding slots are gradually reduced along the first circumferential direction.

19. The motor of claim 18, wherein the winding slots are arranged into a plurality of groups of slots, and the first slots of the plurality of groups are equidistantly arranged along a circumference of the rotor core.

20. The motor of claim 18, wherein radially innermost edges of the third slots are substantially located on an imaginary circle.
